(19) United States
(12) Patent Application Publication
(10) Pub. No.: US 2014/0123819 A1
(43) Pub. Date: May 8, 2014

(54) Torque Limiting Tool and Methods

(71) Applicant: IDEX Health & Science LLC, Oak Harbor, WA (US)

(72) Inventors: Eric Beemer, Anacortes, WA (US); Craig Graham, Anacortes, WA (US); Mark Hahn, Oak Harbor, WA (US)

(73) Assignee: IDEX Health & Science LLC, Oak Harbor, WA (US)

(21) Appl. No.: 14/072,092

(22) Filed: Nov. 5, 2013

Related U.S. Application Data
(60) Provisional application No. 61/723,163, filed on Nov. 6, 2012.

(51) Int. Cl. B25B 23/142; B25B 23/00; B25B 13/48

(52) U.S. Cl. CPC B25B 23/142; B25B 13/48; B25B 23/0007
USPC 81/476; 81/467; 29/428

(57) ABSTRACT

A torque limiting tool is provided that has a handle and a body, which in certain embodiments may be assembled by an operator. The body of the torque limiting tool has a side portion with a tubing slot for allowing tubing to exit the torque limiting tool. The handle and body have one or more abutments, designed to allow the torque limiting tool to deliver a maximum amount of torque. The torque limiting tool may be used with an adapter to allow coupling with a variety of fitting sizes and shapes. The torque limiting tool may be adapted for use with a flat bottom port, such as in an analytical instrument, like liquid chromatography, gas chromatography, ion chromatography, or in in vitro diagnostic systems.

### CROSS-REFERENCE TO RELATED APPLICATION

This application claims the benefit of provisional patent application No. 61/723,163, filed on Nov. 6, 2012, which is incorporated herein by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to tools and methods used to tighten and/or loosen fittings for use in connecting tubing and other components of gas chromatography, liquid chromatography, in vitro diagnostic (IVD) analysis systems, environmental (water) analysis systems, and other analytical systems, and relates more particularly to torque limiting tool and related methods.

2. Description of the Related Art

Liquid chromatography (LC), ion chromatography (IC) and gas chromatography (GC) are well-known techniques for separating the constituent elements in a given sample. In a conventional LC system, a liquid solvent (referred to as the “mobile phase”) is introduced from a reservoir and is pumped through the LC system. The mobile phase exits the pump under pressure. The mobile phase then travels via tubing to a sample injection valve. As the name suggests, the sample injection valve allows an operator to inject a sample into the LC system, where the sample will be carried along with the mobile phase.

In a conventional LC system, the sample and mobile phase pass through one or more filters and often a guard column before coming to the column. A typical column usually consists of a piece of tubing which has been packed with a “packing” material. The “packing” consists of the particulate material “packed” inside the column. It usually consists of silica- or polymer-based particles, which are often chemically bonded with a chemical functionality. When the sample is carried through the column (along with the mobile phase), the various components in the sample migrate through the packing within the column at different rates (i.e., there is differential migration of the solutes). In other words, the various components in a sample will move through the column at different rates. Because of the different rates of movement, the components gradually separate as they move through the column. Differential migration is affected by factors such as the composition of the mobile phase, the composition of the stationary phase (i.e., the material with which the column is “packed”), and the temperature at which the separation takes place. Thus, such factors will influence the separation of the sample's various components.

Once the sample (with its components now separated) leaves the column, it flows with the mobile phase past a detector. The detector detects the presence of specific molecules or compounds. Two general types of detectors are typically used in LC applications. One type measures a change in some overall physical property of the mobile phase and the sample (such as their refractive index). The other type measures only some property of the sample (such as the absorption of ultraviolet radiation). In essence, a typical detector in a LC system can measure and provide an output in terms of mass per unit of volume (such as grams per milliliter) or mass per unit of time (such as grams per second) of the sample's components. From such an output signal, a “chromatogram” can be provided; the chromatogram can then be used by an operator to determine the chemical components present in the sample. Additionally, LC systems may utilize mass spectrometric detection for identification and quantification of the sample, either in addition to, or as an alternative to, the conventional detectors described previously. Ion chromatography relies on the detection of ions in solution, so most metallic materials in the flow path can create interference in the detection scheme, as they create background ions.

In addition to the above components, a LC system will often include filters, check valves, a guard column, or the like in order to prevent contamination of the sample or damage to the LC system. For example, an inlet solvent filter may be used to filter out particles from the solvent (or mobile phase) before it reaches the pump. A guard column is often placed before the analytical or preparative column; i.e., the primary column. The purpose of such a guard column is to “guard” the primary column by absorbing unwanted sample components that might otherwise bind irreversibly to the analytical or preparative column.

In practice, various components in an LC system may be connected by an operator to perform a given task. For example, an operator will select an appropriate mobile phase and column, and then connect a supply of the selected mobile phase and a selected column to the LC system before operation. In order to be suitable for high performance liquid chromatography (HPLC) applications, each connection must be able to withstand the typical operating pressures of the LC system. If the connection is too weak, it may leak. Because the types of solvents that are sometimes used as the mobile phase are often toxic and because it is often expensive to obtain and/or prepare many samples for use, any such connection failure is a serious concern.

Most conventional HPLC systems include pumps which can generate relatively high pressures of up to around 5,000 psi to 6,000 psi or so. In many situations, an operator can obtain successful results by operating a LC system at “low” pressures of anywhere from just a few psi or so up to 1,000 psi or so. More often than not, however, an operator will find it desirable to operate a LC system at relatively “higher” pressures of over 1,000 psi.

Another, relatively newer liquid chromatography form is Ultra High Performance Liquid Chromatography (UHPLC) in which system pressure extends upward to 1400 bar or 20,000 psi. Both HPLC and UHPLC are examples of analytical instrumentation that utilize fluid transfer at elevated pressures. For example, in U.S. Patent Publication No. US 2007/0283746 A1, published on Dec. 13, 2007 and titled “Sample Injector System for Liquid Chromatography,” an injection system is described for use with UHPLC applications, which are said to involve pressures in the range from 20,000 psi to 120,000 psi. In U.S. Pat. No. 7,311,502, issued on Dec. 25, 2007 to Gerhardt, et al., and titled “Method for Using a Hydraulic Amplifier Pump in Ultrahigh Pressure Liquid Chromatography,” the use of a hydraulic amplifier is described for use in UHPLC systems involving pressures in excess of 25,000 psi. In U.S. Patent Publication No. US 2005/0269264 A1, published on Dec. 8, 2005 and titled “Chromatography System with Gradient Storage and Method for Operating the Same,” a system for performing UHPLC is disclosed, with UHPLC described as involving pressures above 5,000 psi (and up to 60,000 psi). Applicants hereby incorporate by reference as if fully set forth herein U.S. Pat. No. 7,311,502 and US Patent Publications Nos. US 2007/0283746 A1 and US 2005/0269264 A1 in their entireties.

It is fairly common for an operator to disconnect a column (or other component) from a LC system and then connect a different column (or other component) in its place after one test has finished and before the next begins. Given the importance of leak-proof connections in LC applications, the operator must take time to be sure the connection is sufficient. Replacing a column (or other component) may occur several times in a day. Moreover, the time involved in disconnecting and then connecting a column (or other component) is unproductive because the LC system is not in use and the operator is engaged in plumbing the system instead of preparing samples or other more productive activities. Hence, the replacement of a colunm in a conventional LC system involves a great deal of wasted time and inefficiencies.

Given concerns about the need for leak-free connections, conventional connections have been made with stainless steel tubing and stainless steel end fittings. More recently, however, it has been realized that the use of stainless steel components in a LC system can have potential drawbacks in situations involving biological samples, and cannot be routinely used for ion chromatography. For example, the components in a sample may attach themselves to the wall of stainless steel tubing. This can present problems because the detector's measurements (and thus the chromatogram) of a given sample may not accurately reflect the sample if some of the sample's components or ions remain in the tubing and do not pass the detector. Perhaps of even greater concern, however, is the fact that ions from the stainless steel tubing may detach from the tubing and flow past the detector, thus leading to potentially erroneous results. Hence, there is a need for “biocompatibie” or “metal-free” connections through the use of a material that is chemically inert with respect to such “biological” samples and the mobile phase used with such samples, so that ions will not be released by the tubing and thus contaminate the sample.

In many applications using selector/injector valves to direct fluid flows, and in particular in liquid chromatography, the volume of fluids is small. This is particularly true when liquid chromatography is being used as an analytical method as opposed to a preparative method. Such methods often use capillary columns and are generally referred to as capillary chromatography. In capillary chromatography, it is often desired to minimize the internal volume of the selector or injector valve. One reason for this is that a valve having a large volume will contain a relatively large volume of liquid, and when a sample is injected into the valve the sample will be diluted, decreasing the resolution and sensitivity of the analytical method.

Micro-fluidic analytical processes also involve small sample sizes. As used herein, sample volumes considered to involve micro-fluidic techniques can range from as low as volumes of only several picoliters or so, up to volumes of several milliliters or so, whereas more traditional LC techniques, for example, historically often involved samples of about one microliter to about 100 milliliters in volume. Thus, the micro-fluidic techniques described herein involve volumes one or more orders of magnitude smaller in size than traditional LC techniques. Micro-fluidic techniques can also be expressed as those involving fluid flow rates of about 0.5 ml/minute or less.

As noted, liquid chromatography (as well as other analytical) systems typically include several components. For example, such a system may include a pump, an injection valve or autosampler for injecting the analyte, a precolumn filter to remove particulate matter in the analyte solution that might clog the column, a packed bed to retain irreversibly adsorbed chemical material, the LC column itself, and a detector that analyzes the carrier fluid as it leaves the column. Ion chromatography may also utilize a suppressor column to facilitate detection dynamic range. These various components may typically be connected by a miniature fluid conduit, or tubing, such as metallic or polymeric tubing (for ion chromatography), usually having an internal diameter of 0.003 to 0.040 inch.

All of these various components and lengths of tubing are typically interconnected by threaded fittings. Fittings for connecting various LC system components and lengths of tubing are disclosed in prior patents, for example, U.S. Pat. Nos. 5,525,303; 5,730,943; and 6,095,572, the disclosures of which are herein all incorporated by reference as if fully set forth herein. Often, a first internally threaded fitting seals to a first component with a ferrule or similar sealing device. The first fitting is threadedly connected through multiple turns by hand or by use of one or more wrenches to a second fitting having a corresponding external fitting, which is in turn sealed to a second component by a ferrule or other seal. Disconnecting these fittings for component replacement, maintenance, or reconfiguration often requires the use of one or more wrenches to unthread the fittings. Although one or more wrenches may be used, other tools such as pliers or other gripping and holding tools are sometimes used. In addition, the use of such approaches to connect components of an LC system often results in deformation or swaging of a ferrule used to provide a leak proof seal of tubing to a fitting or component. This often means that the ferrule and tubing connection, once made, cannot be reused without a risk of introducing leaks or dead volumes into the system. In addition, such approaches may involve crushing or deformation of the inner diameter of the tubing, which may adversely affect the flow characteristics and the pressures of the fluid within the tubing.

The reliability and performance of threaded fluidic fittings is dependent on the amount of torque applied to tighten (or loosen) the fittings. There exists a need for fluidic fittings that are more reliable and have increased performance, which can be accomplished by applying a specific amount of torque to a fluidic fitting. The long used standard of “finger tight” when applying torque introduces a great deal of variation into the process. This results in fittings being under-tightened, which can cause leaks, or potentially over-tightened (e.g., with a tool), which can result in damage to fittings and ports. Preferably, a torque-limited fitting would look and feel like a standard fitting, but reliably and accurately assemble to the correct torque without influence from the user. It would also be required to disassemble like a standard fitting as well. Another approach is to use a torque limiting tool, which would feel like a standard wrench, but it could be used reliably and accurately assemble fittings to the correct torque. Additionally, such a tool could be used on both torque-limited fittings and standard fittings.

U.S. Pat. No. 5,183,140 discloses a general torque limiting mechanism, which comprises two rotatable members, one of which is the driving member and the other of which is the driven member. One of the members includes a single radial projection extending from a central hub that engages a recessed area on the other member. Below the torque limit, the projection engages the recessed area and allows the driving member to drive the driven member. But above the torque limit, the projection disengages the recessed area and prohibits the driving member from driving the driven member. However, such a torque limiting mechanism is adapted for use in relatively large structures such as ATM machines, and not for liquid chromatography or other analytical instrument (AI) systems.

U.S. Pat. Nos. 7,984,933 and 7,954,857 disclose a torque limiting fitting, which also comprises two rotatable members, one of which is the driving member and the other of which is the driven member. One of the members includes a lever extending from a central hub that engages an abutment on the other member. Below the torque limit, the lever engages the abutment and allows the driving member to drive the driven member, but above the torque limit the lever deflects from the abutment and prohibits the driving member from driving the driven member. However the radial projection and the lever are only supported on one end, which can result in inconsistency in the torque limit and generally lower maximum torque values. Similarly, the torque limiting features are each located on a specialized fitting, rather than including the torque limiting features on a separate tool.

It will be understood by those skilled in the art that, as used herein, the term “LC system” is intended in its broad sense to include all apparatus and components in a system used in connection with a liquid chromatography system, and that the discussion of fittings in the context of LC systems is exemplary, as the invention may apply beyond LC systems to gas and ion chromatography, as well as or in vitro diagnostic or environmental analysis, and in other analytical instruments and systems, and may be made of only a few simple components or made of numerous, sophisticated components which are computer controlled or the like. Those skilled in the art will also appreciate that an LC system is one type of an AI system. For example, gas chromatography is similar in many respects to liquid chromatography, but obviously involves a gas sample to be analyzed. Although the following discussion focuses on liquid chromatography, those skilled in the art will appreciate that much of what is said with respect to LC systems also has application to other types of AI systems and methods.

### SUMMARY OF THE INVENTION

The present disclosure overcomes one or more of the deficiencies of the prior art by providing a torque limiting tool that is well-suited for use in liquid chromatography and other analytical instrument systems.

The present disclosure in one embodiment provides a torque limiting tool for use with an analytical instrument system, comprising a handle having a first end and a second end and a passageway therethrough, an inner wall, and a handle abutment attached to said inner wall; and a body having a first end, a second end, a side portion, a tubing slot within said side portion, a body mating portion proximal to said body first end comprising a lip and a recessed portion for mating the body to the handle, and a body abutment proximal to the body first end for securely engaging the handle abutment. The handle can comprise a plurality of abutments. The handle abutment(s) can comprise a first ramp and a second ramp. In certain embodiments, the first ramp can be steeper than the second ramp. In some embodiments, the handle can comprise a plurality of splines. In some embodiments, the body can comprise a plurality of abutments, and the body abutment(s) can comprise a first ramp and a second ramp. In certain embodiments, the first ramp of a body abutment is steeper than the second ramp of a body abutment. In some embodiments, the body mating portion can comprise a spacer. In some embodiments, the body, the handle, or both can comprise polyetheretherketone. In some embodiments, the body can include at least one tube extending through the tubing slot of said body. The torque limiting tool in one embodiment preferably has the length of the tubing slot between 40% and 80% of the total length of said body. In certain embodiments, that fitting can comprise biocompatible materials. A maximum torque can be selected so as to provide a leak-free connection upon tightening of the fitting, and a maximum torque can be selected so as to provide a zero-volume connection upon tightening of the fitting.

The torque limiting tool of the present disclosure can be used with an analytical instrument system comprising a liquid chromatography, gas chromatography, ion chromatography, in vitro diagnostic analysis or environmental analysis system. In certain embodiments, the torque limiting tool can be used as a one-way tool. In certain embodiments, the maximum torque available to loosen a fitting is less than the maximum torque available to tighten a fitting, and in other embodiments, the maximum torque available to loosen a fitting is greater than the maximum torque available to tighten a fitting. In certain embodiments, the tool can deliver a maximum torque value of less than approximately 12 inch-pounds. The torque limiting tool is capable of being used to tighten a plurality of fittings.

One embodiment disclosed is also capable of including an adapter with a first end and a second end, wherein the first end of the adapter is removably coupled to the second end of the body. In certain embodiments, the adapter is capable of receiving a fitting with a ¼″ hex head. In other embodiments, the adapter is capable of receiving a fitting with a knurled head. In yet other embodiments, the adapter is capable of receiving a fitting with a square head. In some embodiments, the body is capable of receiving a fitting of one head size and said adapter is capable of receive a fitting of a different head size. In other embodiments, the body is capable of receiving a fitting of one head shape and said adapter is capable of receive a fitting of a different head shape.

These and other embodiments and advantages of the disclosed torque limited fittings are described below.

### BRIEF DESCRIPTION OF THE DRAWINGS

The following drawings are included to further demonstrate certain aspects and embodiments of the present disclosure. The disclosure and its embodiments may be better understood by reference to one or more of these drawings in combination with the detailed description of specific embodiments presented herein.

FIG. 1 is a block diagram of a conventional liquid chromatography system.

FIG. 2 is a top perspective view of an embodiment of a handle.

FIG. 3 is a top perspective view of the handle of FIG. 2.

FIG. 4 is a bottom perspective view of the handle of FIG. 2.

FIG. 5 is a side perspective view of an embodiment of a body.

FIG. 6 is a perspective view of the body of FIG. 5.

FIGS. 7A, 7B, 7C, 8A, 8B, and 8C are views of a mechanism of securing and unsecuring a handle with respect to a body.

FIG. 9 is a perspective view of an embodiment of a handle coupled to a body.

FIG. 10 is a top sectional view of an embodiment of a handle coupled to a body.

FIG. 11 is a perspective view of an embodiment of a torque limiting tool with a generally circular and knurled handle and an adapter.

FIG. 12 is an exploded perspective view of the torque limiting tool of FIG. 11.

FIG. 13 is a perspective view of an embodiment of a torque limiting tool and an adapter.

FIG. 14 is an exploded perspective view of the torque limiting tool and adapter of FIG. 13.

### DETAILED DESCRIPTION

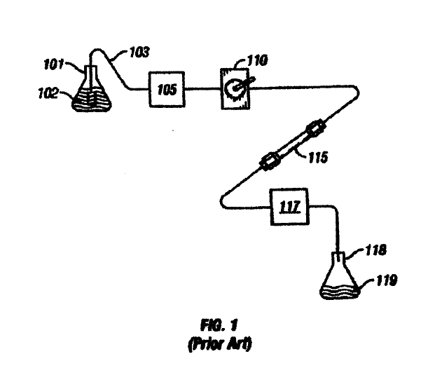

In FIG. 1, a block diagram of certain elements of a conventional liquid chromatography (LC) system is provided. A reservoir 101 contains a solvent or mobile phase 102. Tube 103 connects the mobile phase 102 in the reservoir 101 to a pump 105. The pump 105 is connected to a sample injection valve 110 which, in turn, is connected via tubing to a first end of a guard column (not shown). The second end of the guard column (not shown) is in turn connected to the first end of a primary column 115. The second end of the primary column 115 is then connected via tubing to a detector 117. After passing through the detector 117, the mobile phase 102 and the sample injected via injection valve 110 are expended into a second reservoir 118, which contains the chemical waste 119. As noted above, the sample injection valve 110 is used to inject a sample of a material to be studied into the LC system. The mobile phase 102 flows through the tubing 103 which is used to connect the various elements of the LC system together.

When the sample is injected via sample injection valve 110 in the LC system, the sample is carried by the mobile phase through the tubing into the column 115. As is well known in the art, the column 115 contains a packing material which acts to separate the constituent elements of the sample. After exiting the column 115, the sample (as separated via the column 115) then is carried to and enters a detector 117, which detects the presence or absence of various chemicals. The information obtained by the detector 117 can then be stored and used by an operator of the LC system to determine the constituent elements of the sample injected into the LC system. Those skilled in the art will appreciate that FIG. 1 and the foregoing discussion provide only a brief overview of a simplistic LC system that is conventional and well-known in the art, as is shown and described in U.S. Pat. No. 5,472,598, issued Dec. 5, 1995 to Schick, which is hereby incorporated by reference as if fully set forth herein. Those skilled in the art will also appreciate that while the detailed discussion of certain embodiments herein focuses on a LC system, other analytical systems can be used in connection with various embodiments of the disclosure, such as a mass spectrometry, microflow chromatography, nanoflow chromatography, nano-scale liquid chromatography, capillary electrophoresis, or reverse-phase gradient chromatography system. Indeed, it is believed that a the tools and techniques according to at least some embodiments may be used in a wide variety of applications, including almost any application involving fluid flow and connections.

Preferably, for an LC system to be biocompatible, the various components (except where otherwise noted) that may come into contact with the effluent or sample to be analyzed are made of the synthetic polymer polyetheretherketone, which is commercially available under the trademark PEEK™ from VICTREX®. The polymer PEEK has the advantage of providing a high degree of chemical inertness and therefore biocompatibility; it is chemically inert to most of the common solvents used in LC applications, such as acetone, acetonitrile, and methanol (to name a few). PEEK also can be machined by standard machining techniques to provide smooth surfaces. PEEK has the additional advantage of having a relatively high mechanical strength, as compared to other polymers. Those skilled in the art will appreciate that other polymers may be desirable in certain applications.

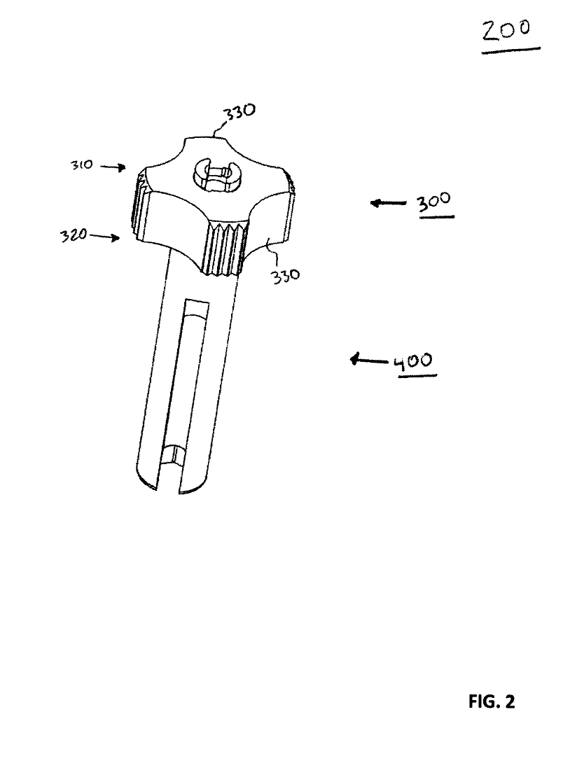

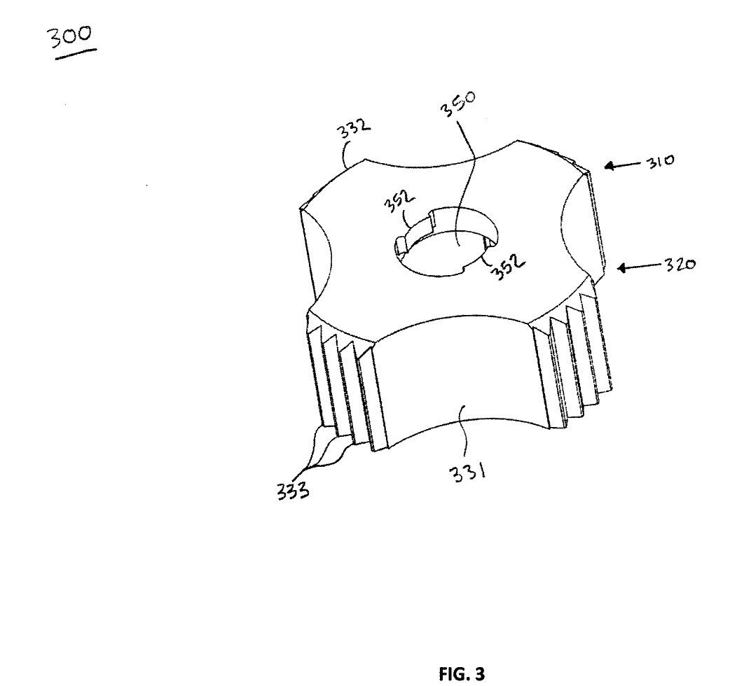

Referring now to FIG. 2, a perspective assembled view of a first embodiment of a torque limiting tool is shown. As shown in FIG. 2, torque limiting tool 200 includes a handle 300 and a body 400. Shown in FIG. 3 is a top perspective view of an embodiment of the handle 300.

Referring now to FIG. 3, a top perspective view of a handle is shown. Handle 300 has a first end 310, a second 320, and a side portion 330. In the embodiment shown in FIG. 3, the side portion 330 of the handle has a concave portion 331, a convex portion 332, and external splines 333. Also shown in FIG. 3 is a passageway 350 which defines an inner wall 351 of the handle. Protruding out from inner wall 351 and proximal to the handle first end 310 is a set of two mating tabs 352. As will be explained later, mating tabs 352 can be used to secure handle 300 to body 400. In a preferred embodiment, mating tabs 352 are substantially equal in size and shape with each other and located across passageway 350 from each other. In this embodiment, two mating tabs are used, though the device can include other amounts of tabs, and the tabs need not be the same size and shape.

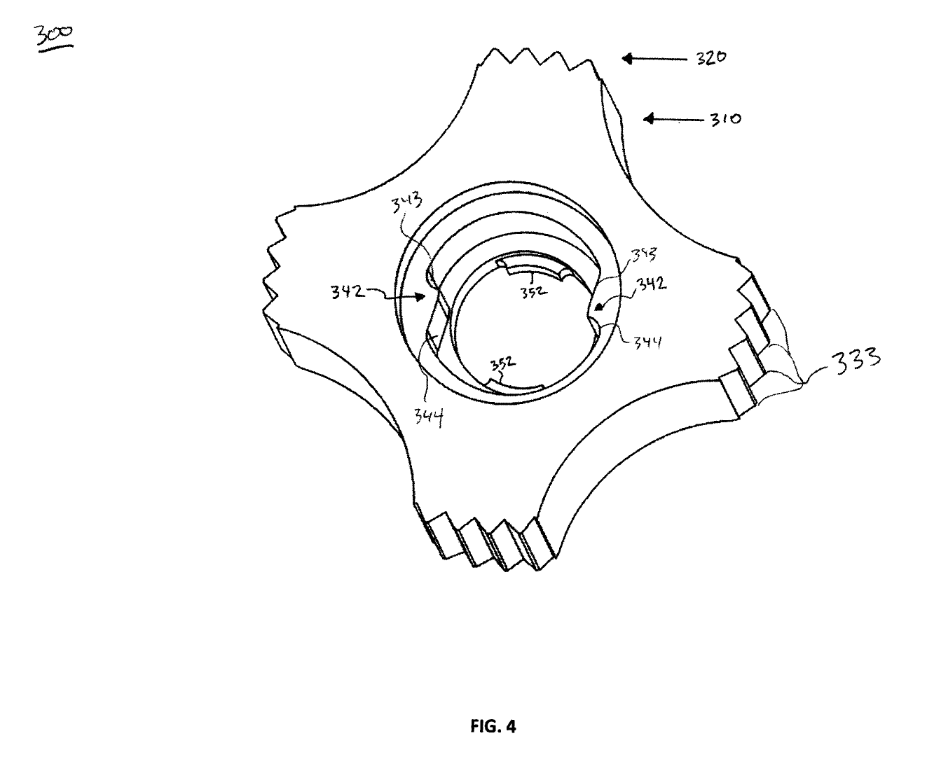

Referring now to FIG. 4, a bottom perspective view of handle 300 is shown. Protruding out from inner wall 351 and proximal to the handle second end 320 is a set of two handle abutments 342. Each handle abutment has a first ramp 343 and a second ramp 344, with first ramp 343 having a steeper slope than second ramp 344 in the preferred embodiment. In this embodiment, handle abutments 342 are substantially equal in size and shape with respect to one another and are located across passageway 350 from each other. As will be explained later, abutments 342 engage with abutments on the body to allow application of a desired amount of torque. In a preferred embodiment, two handle abutments are used, though the device can include fewer abutments or more abutments, and the abutments need not be the same size and shape.

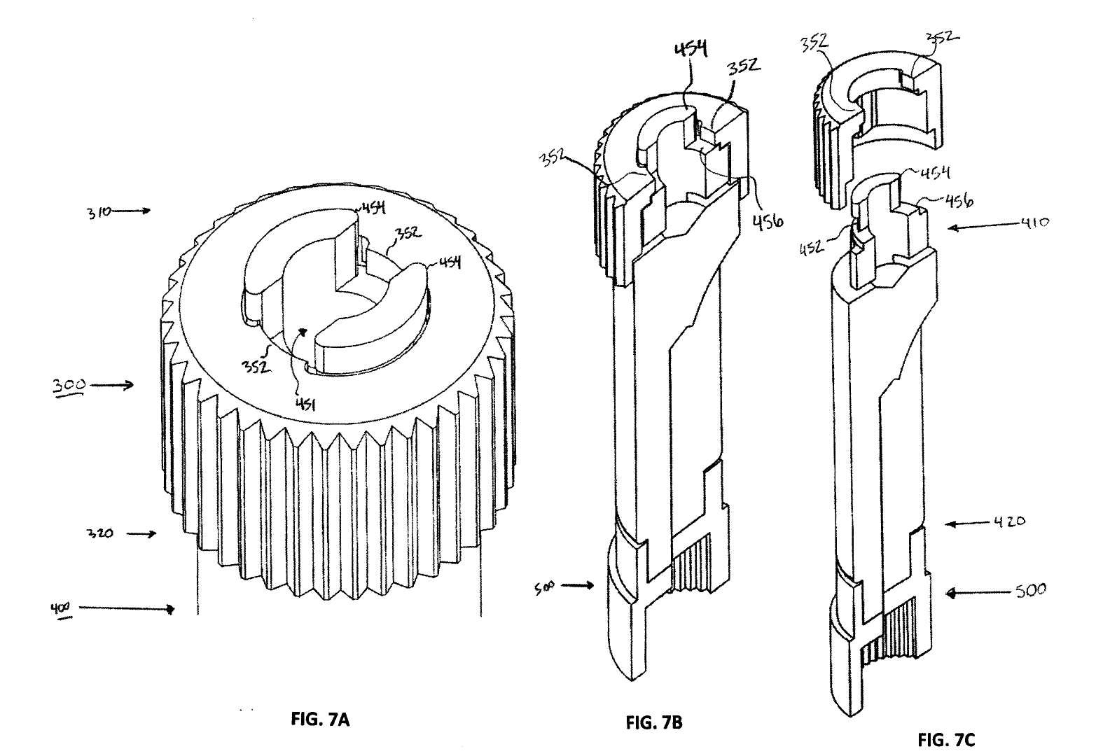

As shown in FIGS. 2-4, handle 300 is generally symmetric about a center axis. Those of skill in the art will realize that a symmetric shape has certain advantages. While the handle 300 in FIGS. 2-4 is shown as being generally “X” shaped, the handle can also be of other shapes. For example, the side portion 330 can be generally circular, as shown in the alternate embodiments of FIGS. 7-12. Further, the handle side portion 330 has splines over a portion of its surface, though that portion can include anywhere from no splines to having the entire surface covered with splines. Similarly, handles of various shapes can be interchangeable with a given body 400. The shapes of the handles can be designed to permit application of different amounts of torque. For example, a generally “X” shaped handle can be designed to apply a higher amount of torque (e.g., from 5-7 inch-pounds), while a knurled and generally circular shaped handle can be used to apply a medium amount of torque (e.g., from 2-5 inch-pounds). Handle 300 can also include a loop, indentation, strap, or other component (not shown) to allow attachment of body 400 to a keychain or lanyard, in order to allow torque limiting tool 200 to be more easily found by an operator.

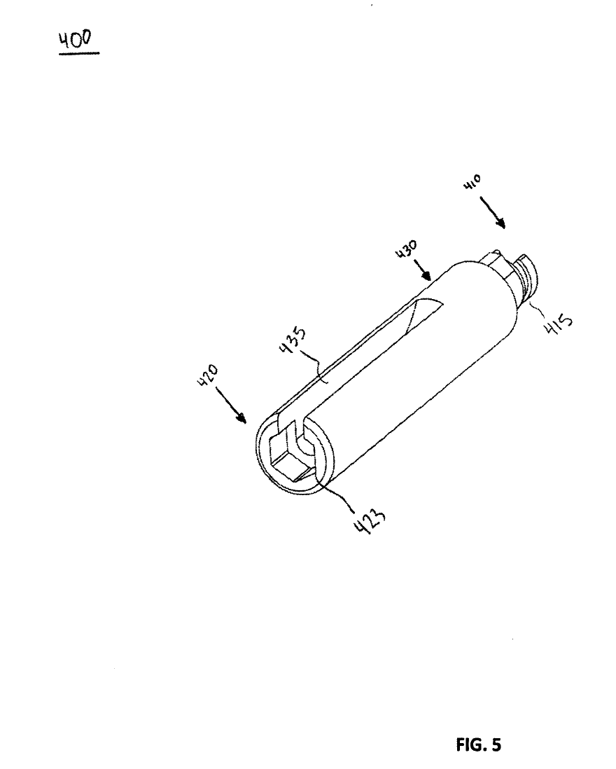

Referring now to FIG. 5, a side perspective view of a body is shown. Body 400 has a first end 410 with body head 415 located proximal thereto, a second end 420, and a side portion 430. Located within side portion 430 is a tubing slot 435, which allows tubing to exit the body. In a preferred embodiment, the length of tubing slot 435 is approximately 60% the length of body 400, though the device can also include a tubing slot 435 with 40-80% the length of body 400, or different ranges. Body 400 can also have a socket 423, located proximal to body second end 420. As shown in FIG. 5, socket 423 can receive a fitting with a ¼ inch hexagonal head. However, socket 423 can be shaped to receive fittings with other heads, such as square or knurled. Similarly, socket 423 can be male or female, and it need not be internal to body 400 but can also be external. Body 400 can also include a loop, indentation, strap, or other component (not shown) to allow attachment of body 400 to some other item, such as a keychain or lanyard, or to an LC or other AI system or component. Doing so allows torque limiting tool 200 to be more quickly and easily found by an operator.

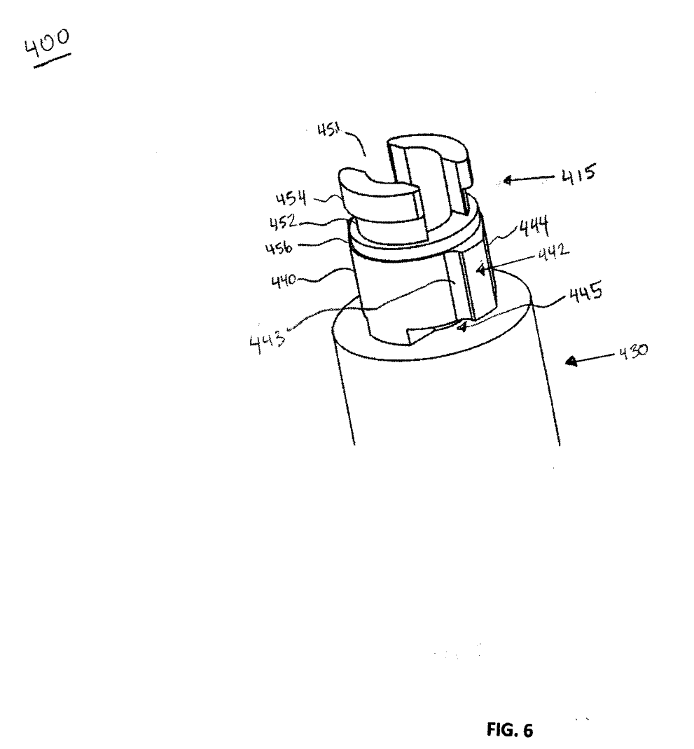

Referring now to FIG. 6, a sectional perspective view of body 400 is shown, in which body head 415 and body side portion 430 can be seen. Body head 415 has a head wall 440 that is connected to body side portion 430. Protruding from head wall 440 are two body abutments 442. Body abutment 442 has a first ramp 443 and a second ramp 444, with first ramp 443 having a steeper slope than second ramp 444 in the preferred embodiment. As will be explained later, body abutments 442 engage with handle abutments 342 to allow application of a desired amount of torque. In a preferred embodiment, the body abutments are substantially equal in size and shape with each another and are located across head wall 440 from each other. In this preferred embodiment, two body abutments are used, though the device can include fewer than or more than two, and the abutments need not be the same size and shape.

Body mating portion 450 is located at a distal end within body head 415 and has a groove 451, lips 454, recessed portion 452, and spacer portion 456. Body mating portion 450 is used to secure/unsecure body 400 to/from handle 300. In the preferred embodiment, lips 454 are shaped as portions of a disc, with the portions separated by head groove 451. In a preferred embodiment, there are two lips, but the device can include more or fewer than two lips. Between lips 454 and head wall 440 is a recessed portion 452 and a spacer 456. Recessed portion 452 is shaped as portions of a disc, with the portions separated by head groove 451. The diameter of lips 454 is larger than that of recessed portion 452, such that lips 454 project beyond recessed portion 452. Head wall 440 has a set of two slots 445 cut out of it. Slots 445 are fluidically coupled to groove 451, such that any fluid that enters the body head through groove 451 can exit the body head through slots 445 (or vice versa). Although two slots 445 are used in this preferred embodiment, the device is not limited to two slots can include fewer slots or more slots.

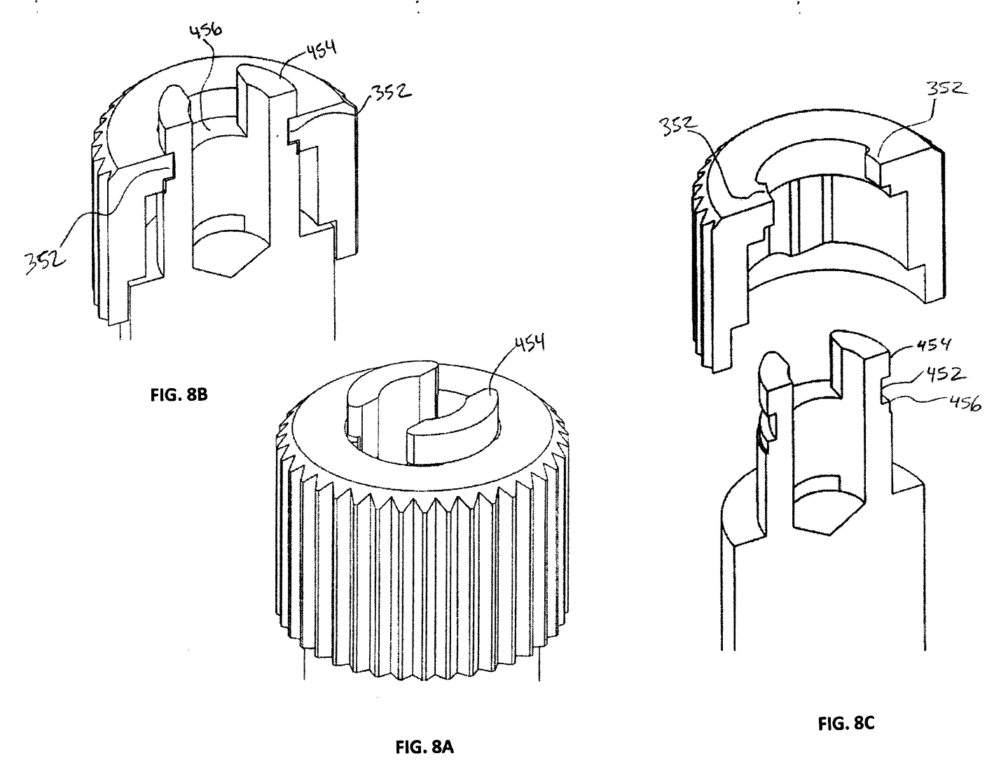

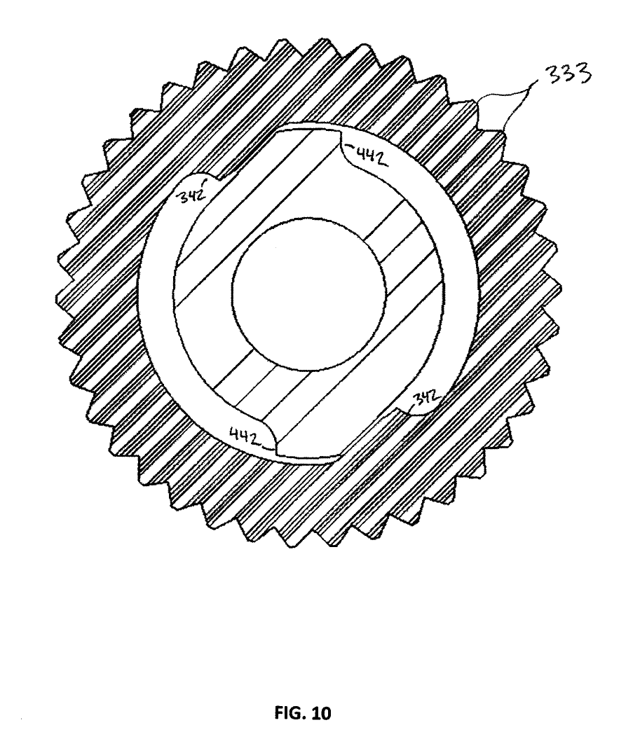

Shown in FIGS. 7A, 7B, 7C, 8A, 8B, and 8C is a mechanism for securing/unsecuring the handle to/from the body. In this embodiment, a knurled handle is used. Shown in FIG. 7A is a perspective view of handle 300 assembled to body 400. Handle 300 is axially aligned with body 400, such that handle passageway 350 is aligned with body mating portion 450. Handle 300 is translated along the axis of body 400, in the direction from body first end 410 towards body second end 420. If handle mating tabs 352 are aligned with head groove 451, as shown in FIGS. 7A-C, then handle 300 can be further translated until lips 454 protrude past the handle first end 310, handle mating tabs 352 are located within head groove 451, and the handle mating tabs 352 sit atop spacer 456 and are co-planar with recessed portion 452. Shown in FIG. 7B is a sectional perspective view of handle 300 coupled to body 400, with handle mating tabs 352 located within head groove 451 and co-planar with recessed portion 452. In this position, handle 300 can be removed from body 400 by translating handle 300 axially in a direction away from body second end 420. To secure handle 300 to body 400, handle 300 can be rotated while keeping body 400 fixed (with respect to the rotating handle). The handle can be rotated until handle abutments 342 engage body abutments 442 (shown in FIG. 10). In a preferred embodiment, handle 300 is rotated clockwise with respect to the body (from the vantage point of looking down on handle first end 410) in order to secure handle 300 to body 400.

Shown in FIG. 8A is a perspective view of an embodiment of a handle after it has been secured to the body; FIG. 8B is a perspective sectional view, and FIG. 8C is an exploded perspective sectional view. To secure handle 300 to body 400, handle 300 is rotated such that lips 454 protrude from handle first end 310, handle mating tabs 352 sit atop spacer 456, and the handle mating tabs and located within recessed portion 452. Handle 300 is constrained from sliding along the axis of the body, in that lips 454 prevent translation of handle mating tabs 352. To unsecure handle 300 from body 400, handle 300 can be rotated until handle mating tabs 352 are aligned with head groove 451 and no longer blocked by lips 454. In a preferred embodiment, handle 300 is rotated counterclockwise with respect to the body (from the vantage point of looking down on handle first end 410) in order to unsecure handle 300 from body 400.

As shown in the figures described herein, handle 300 and body 400 are generally circular and symmetric about a center axis. Those skilled in the art will realize that a circular shape has advantages, but that the outer diameters may have a non-circular shape if desired. For example, handle 300 may have flat, concave, or convex surface portions, to allow an operator to more easily grip and rotate handle 300. In addition, although a plurality of splines 313 are shown on handle 300, the number and presence of such splines are optional.

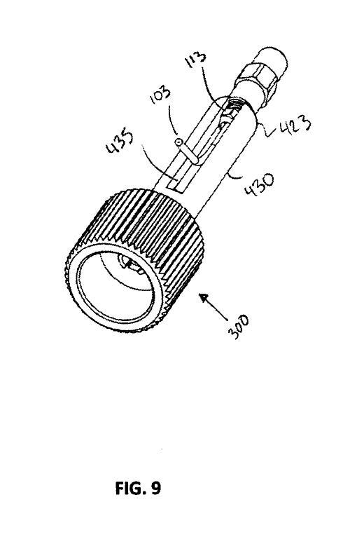

Shown in FIG. 9 is a torque limiting tool coupled to a fitting, such as that used in a liquid chromatography (LC) or other analytical instrument (AI) system. A fitting 113 is shown with tube 103 extending through the fitting. The fitting is coupled to the torque limiting tool 200 via socket 423. In an embodiment, fitting 113 has a ¼ inch hex head. Tube 103 extends through tubing slot 435. As torque limiting tool 200 tightens the fitting (i.e., by rotating the handle clockwise in a preferred embodiment) and/or loosens the fitting, tube 103 can rotate with fitting 113.

Shown in FIG. 10 is a top sectional view of an embodiment of a handle coupled to a body. In this embodiment, abutments 342 and 442 are not symmetrically sloped, in that for a given abutment, one ramp is more steeply sloped (i.e., more vertical) than another ramp. In handle 300, ramp 343 has a steeper slope than ramp 344, as can be seen in FIG. 4. In body 400, ramp 443 has a steeper slope than ramp 444, as can be seen in FIG. 6. When handle 300 is secured to body 400, handle abutments 342 are aligned with body abutments 442. Functionally, as torque limiting tool 200 is used to tighten a fitting (e.g., by turning handle 300 clockwise in an embodiment), handle abutments 342 interfere with body abutments 442. This interference allows torque to be transferred from the handle to the body, such that abutments 342 rotate along with abutments 442. In this embodiment, ramp 344 of the handle contacts ramp 444 of the body during tightening. Abutments 342 and 442 are shaped such that upon reaching a predetermined value of torque, abutments 442 on the body 400 are forced radially towards the center of body 400 and/or the abutments 342 on the handle 300 are forced radially away from the center of body 400 (i.e., the abutments are compressed, similar to a spring). Rotating the handle beyond that threshold torque does not cause a concomitant rotation in the body (and hence, fitting). By having body abutment ramps 443 and 444 with different slops (and/or handle abutment ramps 343 and 344 with different slopes), this allows more torque to be applied to loosen a fitting (e.g., by turning handle 300 counterclockwise in a preferred embodiment) as compared to the maximum torque available to tighten a fitting (i.e., by turning handle 300 clockwise in the preferred embodiment). In this embodiment, ramp 343 of the handle contacts ramp 443 of the body during loosening. Alternatively, the ramp slopes can be designed to allow application of more torque to tighten a fitting as compared to the maximum torque available to loosen a fitting. If the difference in torque is sufficiently large, the torque limiting tool 200 can be designed as a one-way tool, such that it can be used solely to tighten fittings or solely to loosen fittings. One of ordinary skill in the art will understand that the size and shape (as well as materials of manufacture) of the abutments of the handle and body and that of the ramps, are design factors that can be selected to achieve a desired maximum torque to tighten fittings and a different (or same) maximum torque to loosen fittings. Similarly, although two abutments are used in each of the handle and the body, those of skill in the art will understand to use fewer or more abutments as needed. Those of skill in the art may further decide to include slots adjacent to the abutments (in handle, body, or both), and then fix the abutments at either one or both ends to form cantilevers or beams, respectively.

As detailed herein, the torque limiting tool 200 may be adapted to be removably secured to a corresponding portion of a port, a fitting, or a component of an LC or other analytical instrument (AI) system (not shown). Those skilled in the art will appreciate that socket 423 of the body 400 may be adapted so that it can tighten (or loosen) any sized port, fitting, or component of an LC or other AI system (not shown). The use of an internal socket 423 or an external coupler is a matter of selection.

Generally, the torque applied when transferring torque from the torque limiting tool 200 to a fitting 113 of an LC or other AI component accomplishes two major tasks. First, the torque applied to fitting 113 needs to be sufficient to provide a sealed and leak proof connection to an LC or other AI system. In addition, the torque applied to fitting 113 needs to be sufficient so that the tubing 103 is securely held in the fitting and is sufficient to prevent detachment due to the hydraulic force of the fluid moving through the tubing 113. Second, the torque applied should not be so great as to damage the fitting of an LC or other AI system, such that it could introduce leaks or dead volumes into the system. Further, the torque should not be so great as to crush or deform the inner diameter of the tubing, which could adversely affect the flow characteristics and the pressures of the fluid within the tubing.

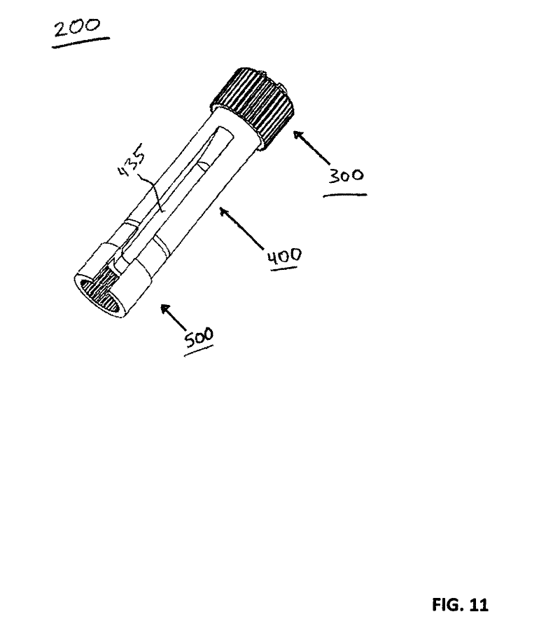

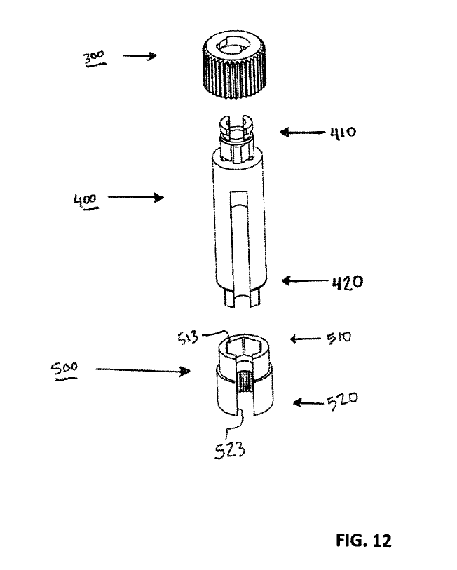

Shown in FIG. 11 is a perspective view of a torque limiting tool in accordance with another embodiment and shown in FIG. 12 is an exploded perspective view. Torque limiting tool 200 has a handle 300 with a knurled side portion, a body 400, and an adapter 500. Adapter 500 has a first end 510 with a proximally located coupling portion 513, and a second end 520 with a proximally located socket 523. Adapter 500 can be secured to body 400 by coupling socket first end 510 to body second end 420, such that body 400 can be used with a wide variety of fittings. For example, and as shown in FIGS. 11 and 12, adapter 500 can be used to adapt body 400 (shown with a hex head) for use with a fitting 113 with a generally circular knurled head. Other fittings can include those with square heads, various size hex heads, etc., and are a matter of selection.

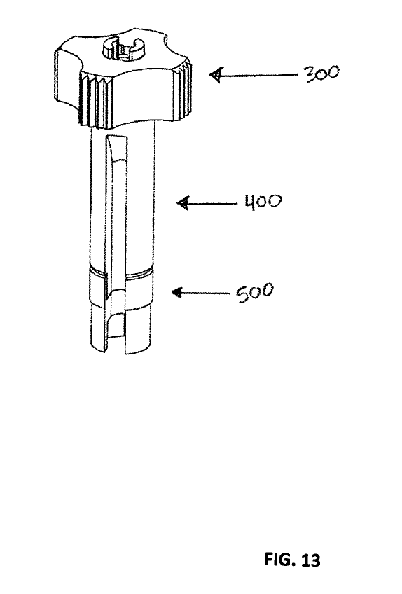

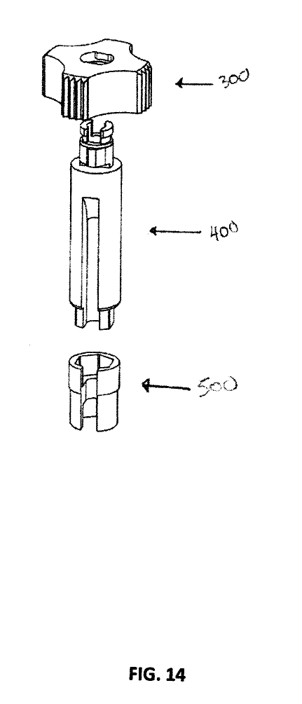

Shown in FIG. 13 is a perspective view of an embodiment of a torque limiting tool and adapter, and shown in FIG. 14 is an exploded perspective view. FIGS. 13 and 14 show a handle 300 that is generally “X” shaped, as in the embodiment of FIGS. 2-4. In the embodiment of FIGS. 13 and 14, adapter 500 can be used to tighten fittings 113 with a non-knurled head, such as fittings with a square head or a hex head. As an additional example, adapter 500 can be used to adapt a body 400 fitted to a ¼ inch hex head to be used with a fitting with a ⅛″ hex head. An advantage of adapter 500 is that it allows flexibility in tool design. For example, the handle 300 and body 400 can be glued together or molded from one piece, and adapter 500 can then be used to allow the unitary tool to be used with various sizes and shapes of fittings.

It will be appreciated that the handle 300, body 400, and adapter 500 can comprise a number of different materials, and that specific materials or combinations of specific materials may be selected, together with or in place of, the selected shape and size of the features of handle 300, body 400, and adapter 500, to obtain desired torque values. For example, handle 300, body 400, and/or adapter 500 in torque limiting tool 200 can comprise a metal, such as stainless steel, or can comprise a different material, such as a polymer, or combinations thereof. As another example, torque limiting tool 200 can comprise components that comprise a polymer, such as polyetheretherketone (PEEK), and the handle 300 and/or the body 400 can comprise stainless steel. It will be appreciated that a variety of metals and polymers may be selected depending on the particular application, as that may involve a particular type of fitting and/or a particular torque range. Polymers that can be used in the manufacture of the handle 300, body 400, and/or adapter 500 include but are not limited to, high performance or commodity grade plastics, PEEK, polyphenylene sulfide (PPS), perfluoroalkoxy (PFA), polyoxymethylene (POM; sold commercially as DELRIN®), TEFLON®, TEFZEL®, polypropylene and ethylene tetrafluoroethylene (ETFE), and combinations thereof. PEEK has the advantage of a high mechanical strength as compared to other polymers. In addition, PEEK (or other polymers) may be used that is reinforced with carbon, carbon fibers, glass fibers, steel fibers, or the like. Additionally, the selection of materials for the tube 113, such as fluorinated ethylene propylene (FEP), perfluoroalkoxy (PFA), PEEK, PEEKsil™, PPS, ETFE, ethylene chlorotrifluoroethylene (ECTFE), stainless steel, or fused silica, may lead to a selection of a particular material for handle 300, body 400, and/or adapter 500. Those skilled in the art will further appreciate that torque limiting tool 200 is shown as a fitting connection for connecting tubing to another component in an LC or other AI system, and that the other component may be any one of wide variety of components. Such components include pumps, columns, filters, guard columns, injection valves and other valves, detectors, pressure regulators, reservoirs, and other fittings, such as unions, tees, crosses, adapters, splitters, sample loops, connectors, and the like.

In certain applications utilizing PEEK, the PEEK used in fabrication of the handle 300, body 400, adapter 500, and/or tubing may be annealed according to manufacturer's recommendations. In general, the PEEK is ramped from about 70° F. to between about 300° F. and about 320° F. over about 40 to about 60 minutes, held at about 300° F. to about 320° F. for about 150 to about 180 minutes, ramped from between about 300° F. and about 320° F. to between about 392° F. and about 560° F. over about 90 minutes to about 300 minutes, held between about 392° F. and about 560° F. for between about 240 minutes and about 280 minutes, and ramped down to between about 70° F. and about 284° F. over about 360 minutes to about 600 minutes. However, those skilled in the art will appreciate that different annealing methods may be used in other applications or as desired.

Methods of using the torque limiting tool 200 (such as shown in FIG. 2 through FIG. 14) are now described in further detail. Torque limiting tool 200 can be provided to the operator with the handle 300, the body 400, and/or the adapter 500 pre-assembled (e.g., glued together or molded together), although in alternate embodiments the operator can assemble the handle 300, body 400, and/or adapter 500 as described herein. In one approach, the operator can insert a portion of the tubing 103 through the passageway in a fitting 113. The operator can then insert the fitting 113 in a port or other component of an LC or other AI system. Assuming the operator or tool supplier has not yet assembled the torque limiting tool, the operator can select a handle 300. The operator may select a handle with a generally “X” shape, as shown in FIGS. 2-4 and 13-14. Such a handle may be used to deliver a higher predetermined value of torque (e.g., 5-7 inch-pounds). Alternatively, the operator may select a handle with a knurled and generally circular shape, as shown in FIGS. 7A-C, 8A-C, 9, and 11-12, to deliver a more moderate amount of torque (e.g., from 2-5 inch-pounds). The predetermined values for torque and handles used to deliver those values are a matter of selection to those of ordinary skill in the art.

The operator then selects a body 400. The body may be selected such that it can couple directly to a fitting, as shown in FIGS. 2, 5, and 9. Alternatively, the body may be selected such that it couples to a fitting through use of an adapter 500, as shown in FIGS. 7B, 7C, 11-14. The body 400 and/or adapter 500 can be selected to match the fitting 113 in use. Though the above referenced figures show the torque limiting tool being used with a standard fitting, an operator can also choose to use the tool with a torque-limited fitting, such as described in U.S. published Patent Application No. 2013/0234432, published Sep. 12, 2013, which is hereby incorporated by reference in its entirety. Use of a torque-limited fitting can be advantageous, in that the torque limiting tool can act as a failsafe with respect to the torque-limited fitting, in case the torque-limited fitting fails to prevent over-tightening of the fitting, or vice versa. Similarly, the torque limiting tool of the present disclosure can be designed with the same predetermined torque value as the torque-limited fitting, or with a different (either higher or lower) predetermined value for torque.

The operator can secure the handle 300 to the body 400 by aligning handle 300 with body 400, such that handle passageway 350 is aligned with body mating portion 450. The operator can then lower the handle along the axis of body 400, in the direction from body first end 410 towards body second end 420. The operator can align handle mating tabs 352 with head groove 451, as shown in FIGS. 7A-C. Handle 300 can be further lowered until lips 454 protrude past the handle first end 310, handle mating tabs 352 are located within head groove 451, and the handle mating tabs 352 sit atop spacer 456 and are co-planar with recessed portion 452. To secure the handle to the body, the operator can rotate handle 300 with respect to body 400 until lips 454 prevent translation of the handle mating tabs 352. The operator can rotate the handle 300 until handle abutments 342 engage body abutments 442. If the operator desires to remove the handle from the body (e.g., to select a different body and/or a different handle), the operator can rotate the handle counterclockwise with respect to the body until handle abutments 342 are located within head groove 451. The operator can then pull the handle 300 away from the body 400 to remove the handle.

Once the handle and body are assembled, the operator can tighten fitting 113 according to the preferred embodiment by rotating handle 300 clockwise such that handle abutments 342 interfere with body abutments 442. Upon rotation, the operator can hold onto tubing 103 with another hand (or the same hand rotating the handle), such that the tubing 103 remains protruding from tubing slot 435 and rotates along with the fitting 113. Alternatively, if the tubing 103 is short enough (compared with the length of body 400), the tubing can remain entirely within body 400 during tightening (or loosening) of the fitting 113. Upon applying a torque that meets or exceeds a predetermined value of torque, abutments 442 on the body 400 are forced radially towards the center of the body and/or the abutments 342 on the handle 300 are forced radially away from the center of the body, thereby compressing the abutments, and the further torque is not transferred to the fitting. Because the maximum torque of the torque limiting tool 200 can be designed based on the specific design of the fitting 113, a leak-proof connection may be obtained by the operator without the use of additional tools such as a wrench, torque wrench, pliers, the “finger tight” criterion, or the like.

We have found that when using a handle 300 and body 400 (without an adapter) made from PEEK to tighten a ¼″ hex head fitting, consistent torque performance has been obtained over numerous cycles. For example, when testing a medium-level torque limiting tool (with a knurled and generally circular handle) over 3,000 cycles, the inventors obtained an average torque of 3.53 inch-pounds with a standard deviation of 0.33 inch-pounds, a maximum of 4.21 inch-pounds, and a minimum of 2.74 inch-pounds. Those of skill in the art can adjust the dimensions of the torque limiting tool, such as the slope/height of an abutment or by including more or less abutments, to obtain a different value for the maximum torque, such as up to 12 inch-pounds for example.

To remove a fitting 113, an operator may either rotate the fitting 113 relative to the port on the LC or other AI system (not shown) in the opposite direction used to connect the fitting 113 to the port, or rotate both the port (or fitting or other component of a LC or other AI system, not shown) and the fitting 113 relative to each other in the opposite direction used to connect the fitting 113. The operator can select a body 400 in which the predetermined torque value for loosening the fitting (i.e., rotating the handle counterclockwise in the preferred embodiment) is larger than the predetermined torque value for tightening the fitting. Alternatively, the operator can select a body in which the predetermined value for loosening a fitting is smaller than the predetermined torque value for tightening the fitting. If the difference in predetermined torque values is sufficiently large, the torque limiting tool can be treated as a one way tool; e.g., it can be used solely for loosening or solely for tightening, depending on the predetermined torque values.

While the disclosure has shown and described various embodiments, those skilled in the art will appreciate from the drawings and the foregoing discussion that various changes, modifications, and variations may be made without departing from the spirit and scope of the invention as set forth in the claims. Hence the embodiments shown and described in the drawings and the above discussion are merely illustrative and do not limit the scope of the disclosure as defined in the claims herein. The embodiments and specific forms, materials, and the like are merely illustrative and do not limit the scope of the invention or the claims herein.

We claim:

1. A torque limiting tool for use with an analytical instrument system, comprising:
a) a handle having a first end and a second end and a passageway therethrough, an inner wall, and a handle abutment attached to said inner wall; and
b) a body having a first end, a second end, a side portion, a tubing slot within said side portion, a body mating portion proximal to said body first end comprising a lip and a recessed portion for mating the body to the handle, and a body abutment proximal to the body first end for engaging the handle abutment.

2. The torque limiting tool according to claim 1, wherein said handle comprises a plurality of abutments.

3. The torque limiting tool according to claim 1, wherein said handle abutment comprises a first ramp and a second ramp.

4. The torque limiting tool according to claim 3, wherein the first ramp comprises an angled portion steeper than an angled portion of the second ramp.

5. The torque limiting tool according to claim 1, wherein said handle comprises a plurality of splines.

6. The torque limiting tool according to claim 1, wherein said body comprises a plurality of abutments.

7. The torque limiting tool according to claim 1, wherein said body abutment comprises a first ramp and a second ramp.

8. The torque limiting tool according to claim 7, wherein the first ramp comprises an angled portion steeper than an angled portion of the second ramp.

9. The torque limiting tool according to claim 1, wherein said body mating portion comprises a spacer.

10. The torque limiting tool according to claim 1, wherein said handle or said body comprises polyetheretherketone.

11. The torque limiting tool according to claim 1, wherein said handle and said body each comprise polyetheretherketone.

12. The torque limiting tool according to claim 1, further including at least one fitting within said body and at least one tube extending through the tubing slot of said body.

13. The torque limiting tool according to claim 4, wherein at least one of the angled portion of the first ramp and the angled portion of the second ramp is configured to provide a desired maximum torque.

14. The torque limiting tool according to claim 1, wherein said analytical instrument system comprises a liquid chromatography, gas chromoatography, ion chromatography, in vitro diagnostic analysis or environmental analysis system.

15. The torque limiting tool according to claim 1, wherein the maximum torque available to tighten a fitting is less than the maximum torque available to loosen a fitting.

16. The torque limiting tool according to claim 1, wherein the length of said tubing slot is between 40% and 80% of the total length of said body.

17. A torque limiting tool for use with an analytical instrument system, comprising:
a) a handle having a first end and a second end and a passageway therethrough, an inner wall, and a handle abutment attached to said inner wall;
b) a body having a first end, a second end, a side portion, a tubing slot within said side portion, a body mating portion proximal to said body first end comprising a lip and a recessed portion for mating the body to the handle, a body abutment proximal to the body first end for engaging the handle abutment; and
c) an adapter with a first end and a second end, wherein the first end of the adapter is removably coupled to the second end of the body.

18. The torque limiting tool according to claim 17, wherein said handle comprises a plurality of abutments.

19. The torque limiting tool according to claim 17, wherein said handle abutments comprise a first ramp and a second ramp.

20. The torque limiting tool according to claim 17, wherein said body comprises a plurality of abutments.

21. The torque limiting tool according to claim 17, wherein said handle and said body each comprise polyetheretherketone.

22. The torque limiting tool according to claim 17, further comprising at least one fitting located at least partially within said body and at least one tube extending at least partially through the tubing slot of said body.

23. The torque limiting tool according to claim 17, wherein said analytical instrument system comprises a liquid chromatography, gas chromatography, ion chromatography, in vitro diagnostic analysis or environmental analysis system.

24. The torque limiting tool according to claim 17, wherein said body is adapted to receive a fitting of one head size and said adapter is adapted to receive a fitting of a different head size.

25. The torque limiting tool according to claim 17, wherein said body is adapted to receive a fitting of one head shape and said adapter is adapted to receive a fitting of a different head shape.

26. A method of connecting components in an analytical instrument system comprising:
a) receiving a torque limiting tool, the torque limiting tool having:
i) a handle having a first end and a second end and a passageway therethrough, an inner wall, and a handle abutment attached to said inner wall; and
ii) a body having a first end, a second end, a side portion, a tubing slot within said side portion, a body mating portion proximal to said body first end comprising a lip and a recessed portion for mating the body to the handle, and a body abutment proximal to the body first end for engaging the handle abutment;
b) coupling the torque limiting tool to a fitting; and
c) rotating the handle of the torque limiting tool to tighten the fitting.
